(19) United States
(12) Patent Application Publication
(10) Pub. No.: US 2014/0321773 A1
(43) Pub. Date: Oct. 30, 2014

(54) IMAGE-BASED DATA RETRIEVAL

(71) Applicant: SIEMENS AKTIENGESELLSCHAFT, Munich (DE)

(72) Inventors: Matthias HAMMON, Nuremberg (DE); Martin KRAMER, Erlangen (DE); Sascha SEIFERT, Erlangen (DE)

(21) Appl. No.: 13/873,351

(22) Filed: Apr. 30, 2013

(51) Int. Cl. G06F 17/30

(52) U.S. Cl. CPC G06F 17/30247
USPC 382/305

(57) ABSTRACT

A rendering device, a control method for a graphical user interface and a computer software product are disclosed. The rendering device includes an input interface, a parser interface and a retrieval unit, designed for the automatic generation of a search function for retrieval from accessible databases by reference to a specific semantic identifier, in order to acquire reference data, in combination with control data, for display on the graphical user interface.

### FIELD

At least one embodiment of the present invention generally relates to the fields of medical technology and information technology, and more specifically relates to a rendering unit, a method and/or a system for the control of a graphical user interface for the representation of medical data. A purpose of at least one embodiment involves the display of medical image data together with additional and personalized information sources which are accessible via the Internet.

### BACKGROUND

Specifically in the field of radiology, but also in the field of medicine in general, the planning of treatment and the conduct of special examinations is dependent upon rapid access to personalized information sources. To this end, it is generally necessary to access image data for the patient concerned in a variety of formats (computed tomography images, magnetic resonance tomography images, ultrasound images, etc.), and to use this data as the basis of a search for further information. Even at the diagnostic or reporting stage, and in the interpretation of diagnostic results, it is necessary to take far-reaching decisions for the patient concerned, which are generally based upon images retrieved (for example from radiology). However, decisions cannot be reached on the basis of these images alone, but require the consideration of additional background information, which may be derived e.g. from the anatomical examination of the relevant part of the body, from pathological findings or from general guidelines.

In everyday clinical practice, the problem arises that not every doctor will have rapid access to this information. Conversely, the extraction of relevant and applicable documents and information from the comprehensive range of reference literature and research literature in any given field will, in many cases, require substantial expenditure of time and effort. Hand-written instructions or notes (e.g. in the form of hand-written Post-It notes) are frequently used as a means of indicating the most appropriate databases for any specific issue.

Existing computer-based diagnostic systems do not incorporate any option for a data retrieval facility for additional information which operates on the basis of the representation of medical images.

### SUMMARY

At least one embodiment of the present invention is directed to an efficient and personalized information retrieval system which operates on the basis of medical images. It is also intended that the efficiency and quality of execution of the diagnostic process should be enhanced in at least one embodiment. Moreover, data sources which are available via the Internet should be made accessible on a personalized basis for diagnostic purposes in at least one embodiment.

Disclosed are a device, a method, a computer software product and/or computer program, and a medical diagnostic system.

The main example embodiment according to the invention is described hereinafter with reference to the method claimed. Any features, advantages or alternative embodiments described for this purpose are also applicable to the remaining subject matter of the invention, and vice versa. In other words, the substantive claims (relating by way of example to a system, a device or a product) may be further developed to include characteristics which are described or claimed in respect of the method, and vice versa. The corresponding functional characteristics of the method are delivered by corresponding substantive modules, specifically by hardware modules.

According to one example embodiment, the present invention relates to a method for the control of a graphical user interface for the purposes of data retrieval of medical reference data from a variety of databases which are accessible via the Internet, subject to the relevant access criteria. The retrieval of medical reference data is to be executed on the basis of at least one image which is represented on the graphical user interface, or at least one partial image.

A device of at least one embodiment is for the control of a graphical user interface for the representation of medical reference data in the form of search results on at least one image, comprising:

an input interface for the inputting of at least one image, and for the acquisition and localization of at least one input signal on the graphical user interface,

a parser interface to an image parser, which is designed for the parsing of an imported image, in order to allow the generation and classification of at least one identifier for the image or partial image concerned, and

a retrieval unit, which is designed for the automatic generation of a search function for the retrieval of data from a variety of accessible databases, wherein the search function is based upon the identifier specified, in order to allow the acquisition of reference data,

wherein the rendering device is designed to control the graphical user interface, such that the processed reference data will be inserted in the image at a predetermined insertion position and/or in a pre-configurable insertion format, by the application of pre-configured insertion parameters (e.g. for duration), and displayed together with the image concerned.

The embodiments of the method according to the invention described above may also be configured as a computer software product with a computer program, wherein the computer will proceed with the execution of the method according to embodiments of the invention, as described above, when the computer program concerned is run on a computer or a computer processor.

An alternative example embodiment also comprises a computer program with a computer program code for the execution of all the method steps in the method claimed or described above, when the computer program is run on the computer. To this end, the computer program may also be stored on a machine-readable storage medium.

An alternative example embodiment involves the provision of a storage medium, which is designed for the storage of the computer-implemented method described above, and can be read by a computer.

### BRIEF DESCRIPTION OF THE DRAWINGS

In the detailed description of the figures set out below, example embodiments, with their associated characteristics and further advantages, are presented with reference to the drawing, but not by way of limitation. The drawings show:

FIG. 1 an overview of modules according to an example embodiment of the invention,

FIG. 2 a data flow of a method according to an example embodiment of the invention,

FIG. 3 an example of reference data inserted on a graphical user interface, and

FIG. 4 a further example of inserted reference data, with associated referral.

The invention is described in greater detail hereinafter, with reference to the figures attached.

### DETAILED DESCRIPTION OF THE EXAMPLE EMBODIMENTS

The present invention will be further described in detail in conjunction with the accompanying drawings and embodiments. It should be understood that the particular embodiments described herein are only used to illustrate the present invention but not to limit the present invention.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

The main example embodiment according to the invention is described hereinafter with reference to the method claimed. Any features, advantages or alternative embodiments described for this purpose are also applicable to the remaining subject matter of the invention, and vice versa. In other words, the substantive claims (relating by way of example to a system, a device or a product) may be further developed to include characteristics which are described or claimed in respect of the method, and vice versa. The corresponding functional characteristics of the method are delivered by corresponding substantive modules, specifically by hardware modules.

According to one example embodiment, the present invention relates to a method for the control of a graphical user interface for the purposes of data retrieval of medical reference data from a variety of databases which are accessible via the Internet, subject to the relevant access criteria. The retrieval of medical reference data is to be executed on the basis of at least one image which is represented on the graphical user interface, or at least one partial image.

According to one example embodiment of the invention, there is provision for all images or partial images which are to constitute the basis for data retrieval to, in principle, undergo a pre-processing stage. This pre-processing stage involves the inputting of the image concerned (this may be effected by way of example via an input interface), which then undergoes a parsing process. The parsing process is customarily based upon the segmentation of the image concerned, in order to allow the identification of specific anatomical elements. To this end, after segmentation into anatomical regions, the image is compared with an applicable reference ontology, in order to assign at least one meaningful concept (e.g. heart, heart valve, etc.) to the image concerned. In principle, different methods are available for image parsing. The object of the pre-processing of an image is to generate an association between the image concerned, or specific sections of that image, and specialist medical concepts.

After this pre-processing, it is possible to execute the control method for the graphical user interface described hereinafter, once the relevant image or multiple images or partial images are depicted on the user interface.

In the absence of the input or detection of any other activation signals on the graphical user interface, the system will assume a display mode. The display mode is restricted purely to the representation of data, such as images or texts. An activation signal sent to the graphical user interface, makes it possible to switchover from the display mode to a search mode. The function of the search mode is the identification of specific areas of the image, images or partial images by means of an actuating input signal, which will be used subsequently for the purposes of data retrieval. The mouse can be moved on the user interface in the customary manner, such that, by way of example, a mouse function (for example the left mouse button) can be used to generate the input signal. The position of the generation of the input signal on the graphical user interface, in relation to the image represented, will be recorded automatically in this case. In other words, the input signal is localized on the user interface, thereby permitting a computer processor to determine the anatomical region(s) to which the input signal relates. On the basis of the results of the parsing process, localization data can then be used for the generation of an (anatomical) identifier, or a plurality of identifiers, for the input signal.

Once an identifier, or a list of identifiers, has been generated, a search function can be automatically evaluated for the purposes of retrieval from accessible databases, in order to allow the retrieval of reference data for the image or the partial image concerned.

Thereafter, the graphical user interface can be controlled by corresponding control signals in order to permit the insertion of the retrieved and, where applicable, processed reference data at a predetermined insertion position on the image represented and the reprocessing thereof, in combination with the image, to form a new graphical representation.

In essence, the present application relates to automated, efficient and personalized access to information sources via a network, specifically via the Internet, which are identified by means of navigation in the images or image zones concerned. The additional information displayed can be provided as reference data for computing processes and/or as additional anatomical, statistical, diagnostic and/or therapeutic information. A key element is the retrieval of reference data from a variety of different and accessible databases, and the automatic representation of these data on the graphical user interface, e.g. in the form of a hyperlink. Accordingly, an automatic and area-specific search on a given image, with corresponding search results, can be generated automatically, without the need for the practitioner to submit manual queries to different databases, to view results and proceed with the manual incorporation thereof in the respective process.

Concepts applied for the purposes of embodiments of the present application are described in greater detail hereinafter.

The user interface is preferably configured as a graphical user interface of a computer-controlled device, such as for example a PC, a tablet PC, a smartphone or another computer device (for example a monitor). The user interface comprises an input and output interface for the acquisition of input signals (for example using the mouse or by means of a surface activation function in the case of a touchscreen). The output interface is preferably used for the representation of content in various formats (e.g. medical images or reports in text form), etc. Images are preferably processed in a specific format, specifically in a DICOM format (DICOM: Digital Imaging and Communications in Medicine), which is defined as a public standard for the storage and exchange of medical information. Alternatively, however, another standard may be applied for this purpose.

An example embodiment of the retrieval function is directed to medical reference data which has been sourced from various databases. To this end, a variety of databases are accessed for the conduct of a search in a pre-processing stage. Additional security measures (e.g. authentication measures) may be applied for this purpose. It is essential that the databases concerned should be accessible via the Internet, or via another network.

Activation of the search mode involves the acquisition of an activation signal. Preferably, this will be effected via the user interface. Alternatively, however, the input of this signal may proceed by another means (e.g. using the mouse, or via an acoustic data interface). Following the acquisition of an activation signal, the system will switch over from display mode into search mode. As a consequence, signals on the user interface will be detected as input signals. In other words, for example, a mouse click on the user interface (or the application of pressure to a specific image zone on a touchscreen) will be detected as an input signal in search mode. Thereafter, positional data associated with this input signal is recorded and applied as a basis for the definition of the relevant identifier. Naturally it is possible to acquire, not only a single input signal, but a series of input signals, which may relate to different image segments or partial images respectively. The identifier is then defined on the basis of this plurality of input signals. As a consequence, a list of identifiers will generally be produced, which will then be used for the generation of a search function.

In general, the input signal will invariably take the form of a signal on the graphical user interface, and may be generated in the form of a mouse click, a double click, or by hovering the mouse over a specific area of the image concerned. Alternatively, an acoustic input signal may be processed for this purpose. Alternative embodiments provide for different forms of input signal (e.g. text input in a data field provided for this purpose).

The identifier is an electronic data record which defines a specific anatomical region and which may be represented e.g. by a bit string. The identifier is applied as a basis for the generation of a query in the relevant databases. The search query can preferably be generated in various formats (e.g. in SQL-based formats or in SQL extensions, such as CQL—Continuous Query Language—or similar). In an example embodiment, and depending upon the number of databases accessed, it is also possible to generate, not only a single search function, but a plurality of search functions, which can be deliberately tailored to the databases concerned. Accordingly, it is also possible to generate a number of different search queries, which may be applied to the different databases. Following the acquisition of the respective database results, said database results are combined and consolidated into a single result. The consolidated result is then displayed on the graphical user interface. This display may take the form e.g. of an inserted pop-up window and/or hyperlinks, which may be activated for the purposes of referral to the relevant Internet source or electronic database, by way of example.

In general, the consolidated result of the database retrieval function is processed by the application of predetermined data processing functions to generate reference data. A number of processes may be applied for this purpose. On the one hand, it is possible for the various database results to be combined or consolidated into one single overall result. In more complex and alternative embodiments, the various database results may undergo further processing steps, which may involve, by way of example, the activation of a hyperlink and the direct insertion of the respective reference on the user interface. It is also possible for the database result to be converted into a different data format. In a preferred embodiment, further selection steps are applied, the object of which is to restrict the database result (of the search function) by reference to personalized criteria which are able to be predefined (by way of example, it is possible for a user to specify that only reference data from specific databases should be displayed. It is also possible for the user to stipulate that only image data, and no text data, should be displayed. Further (time- and/or anatomically-dependent) restriction criteria may be applied). In a preferred embodiment, it is possible to configure which processing steps are to be applied to search results, for the purposes of the generation or processing of reference data.

Reference data will be incorporated at a predetermined insertion position on the image concerned. The insertion position is defined by a specific field, in which a pop-up window is generated on the user interface to display reference data. This may proceed, by way of example, at the position of acquisition of the input signal on the user interface. Alternatively, it is possible for the insertion position to be integrated at a different position on the interface, in order to ensure that the anatomical region upon which the input signal was entered is not masked by the reference information. It is also possible to configure the format, the size and/or the position of representation of the reference data. It is also possible to set the length of time for which the reference data are to be displayed on the interface. For example, it is possible that the reference data will only be displayed for such time as the user holds the mouse over the relevant anatomical region. As soon as the user switches to a different graphical representation, the reference data can be blanked out again.

Accordingly, the user can hover over an imported and parsed image and define, by way of a specific user interaction, for example a mouse click, a specific anatomical region or a plurality of anatomical regions, on the basis of which a search will then be executed in the databases. By way of user interaction, the user can also define a specific partial image (e.g. an anatomical segment, such as a heart valve in the representation of a heart), for which an identifier is then defined, by which access to the relevant database(s) will then proceed.

The definition of the relevant identifier will proceed by reference to and the application of medical ontology systems, such as Radlex (http://www.radlex.org/), Foundational Model of Anatomy (http://sig.biostr.washington.edu/projects/fm/). A significant and prominent ontology in the healthcare sector is Snomed-CT (http://www.ihtsdo.org/snomed-ct/). In variations of embodiments, ontology systems from the field of life science may also be used. According to one example embodiment of the invention, it is possible to access a portal via which the various ontologies may be consulted, such as e.g. the search site (http://bioportal.bioontology.org). The identifier will preferably be a semantic identifier, as it is based upon the positional coordinates of the input signal acquired and, accordingly, upon a classification of anatomical units.

As mentioned above, both the activation signal and the input signal are entered directly on the graphical user interface. Alternatively, however, the activation signal and/or the input signal may be entered via alternative interfaces (key combinations on a connected keyboard, a speech-based command or an instruction in other data formats).

It is generally provided that the relevant semantic indicator defined will be saved together with the relevant image. This has the advantage of allowing which input signals have been entered by the user to be traced, thereby permitting the generation of a search history, by way of example.

There is also provision for saving the result of the pre-processing stage. Imported and parsed images or partial images are also stored in a memory, from which they can then be retrieved for the execution of an region-specific search on a given image.

A parser or image parser, which is designed for the parsing of the image, may operate in accordance with known methods, as described by way of example in: S. Seifert et al.; “Hierarchical Parsing and Semantic Navigation of Full Body CT Data”, SPIE 2009, the entire contents of which are hereby incorporated herein by reference.

In an example embodiment, provision is made for the identifier to comprise a number of segments, which relate to different sections of the image or to different images. Accordingly, the search function may be generated on the basis of all, or a selection of the selected partial images or images. This has the advantage of further refining the search function, in that the user can enter a number of input signals in the images or image zones represented. These input signals are then used in combination for the generation of the search function.

In an example development of the invention, it can be determined automatically whether a number of input signals have been acquired for the same partial image (and, accordingly, for the same anatomical region). In this case, the multiple input signals will be redundant, as they refer to the same image zone. In this case, it is stipulated that only one of this plurality of input signals, which refer to this same image zone, will be used for the search. This ensures that, whilst all input signals will be considered for search purposes, the search result will be delivered as quickly as possible, in that only the relevant input signals will be used for the generation of the search function.

According to one example embodiment of the invention, an expansion function is applied, whereby the identifier(s) specified may be extended by reference to the input of a medical processing function or workflow, such that the search function is executed on the basis of the specified and expanded identifiers. Accordingly, the search function can be more accurately tailored to the relevant application situation, in that the medical workflow is considered in the search function. It may be taken into consideration, for example, whether the search is to be executed for the purposes of a diagnosis or as part of a clinical study. In the latter case, the list of identifiers can, in many instances, be usefully extended, and the search function may be expanded to include statistical information, such as mortality rates, etc., which is not of relevance in another application context.

In a further embodiment, a selection function may be applied, by which the search function may be subject to user-specific restriction on the basis of previously configured criteria. This allows more personalized searching to be carried out. It is possible e.g. to consider user-specific selection criteria which will ensure, e.g. that a search is only to be conducted in specific databases, or that no basic anatomical information is delivered as reference data, thereby ensuring that the attending physician is not encumbered with unnecessary data.

According to a further example embodiment of the invention, a training function may be applied. The training function may be implemented using artificial intelligence processes and may be based upon computerized training methods. To this end, it may be provided that the selection of reference data will be executed and controlled on the basis of recorded referrals to previously executed searches. The training function may be designed for the generation of default reference data. This has the advantage, that the area-specific search function on a given image can be progressively improved, and the function configured as a self-training system. As multiple search applications are executed, it is therefore possible to achieve the further refinement of the search, such that only frequently sought-after reference data will be displayed as proposed options, whilst rarely sought-after reference data will be classified as subordiante, with lower priority.

In general, the search result will comprise a number of reference data records and, accordingly, for example a number of hyperlinks. According to one aspect, a prioritization function can now be applied to the search result. The object of the prioritization function is to sort the search results identified (for example the various hyperlinks) by predetermined criteria, such that the most important search results will be uppermost in the list, and the less significant results will be arranged below.

According to one example embodiment, a pop-up dialogue panel will be displayed on the graphical user interface, which is either supplementary or integral to the reference data inserted in the image concerned. The user may enter further processing commands using the dialogue window displayed. These processing commands may relate, by way of example, to the prioritization of search results or to a feedback function in respect of the search results identified.

In a further embodiment, a preliminary setting can be applied for the determination of the form in which the reference data are to be inserted on the user interface. On the one hand, it is possible to insert only a single referral to the reference source in the database (e.g. in the form of a hyperlink). On the other hand, it is possible for the hyperlink to be activated beforehand, resulting in the direct representation of a summary display from one section of the database. This configurability is particularly advantageous where the reference data concerned relates to comprehensive data collections (e.g. from PubMed).

A device of at least one embodiment is for the control of a graphical user interface for the representation of medical reference data in the form of search results on at least one image, comprising:

an input interface for the inputting of at least one image, and for the acquisition and localization of at least one input signal on the graphical user interface, a parser interface to an image parser, which is designed for the parsing of an imported image, in order to allow the generation and classification of at least one identifier for the image or partial image concerned, and

a retrieval unit, which is designed for the automatic generation of a search function for the retrieval of data from a variety of accessible databases, wherein the search function is based upon the identifier specified, in order to allow the acquisition of reference data,

wherein the rendering device is designed to control the graphical user interface, such that the processed reference data will be inserted in the image at a predetermined insertion position and/or in a pre-configurable insertion format, by the application of pre-configured insertion parameters (e.g. for duration), and displayed together with the image concerned.

The input interface may be configured as a conventional commercial serial interface for serial data transmission in accordance with various standards, including e.g. Ethernet, USB, Firewire, CAN-Bus or RS-485 interfaces. Alternatively, parallel interfaces may be used (for example Centronics or ECP). Preferably, however, a USB interface will be used.

The rendering device will comprise, in at least one example embodiment, an activation signal interface, which is designed for the acquisition of an activation signal (e.g. on the interface or by means of a keypad). The activation signal effects the switchover from a display mode to a search mode, in which the automatic search function for reference data is activated.

The parser may be configured as a processor or as a hardware component. The retrieval unit may be deployed either in the software or in the hardware, and is a constituent element of the rendering device. The parser may also be configured as a component of the rendering device. Alternatively, the parser may be arranged as an external module, which is only connected to the rendering device via the parser interface for the purposes of data exchange.

In an example embodiment, the rendering device comprises a memory, which is designed for the storage of results and/or interim results. Specifically, the memory may incorporate a classification function for images, partial images and identifiers. Parsed images may also be saved, in order to be retrieved in future searches. The parsing of images is not necessarily a constituent element of the search function, and may also be executed in a pre-processing stage, whereby parsed images will be retrieved from the memory beforehand. The memory may also incorporate a classification function for the association of the processed reference data (displayed as a search result), the predefined insertion position and/or the relevant image or partial image with its respective identifier. In less complex embodiments, less data may be stored in the memory, such that only part of the above-mentioned classifications may require storage.

According to one example embodiment, the image comprises a plurality of partial images, wherein each of the individual partial images is separately identified and separately associated with different identifiers. For example, where a heart is represented, it is possible to use this characteristic, not only for the semantic identification of the heart itself by a single identifier, but also for the separate and individual semantic identification of components of the heart (e.g. the left and right ventricles), whereby a search can be executed thereafter on this basis.

A further example embodiment of the invention relates to a diagnostic image system for medical image data, specifically X-ray-based image data, having a rendering device of the type described above. It should be borne in mind that the rendering device can be expanded by the incorporation of additional units for the delivery of the functionality or functionalities described above in respect of the method.

However, example embodiments of the invention are not limited to a diagnostic application (for diagnostic purposes, the search conducted generally relates to diagnostic results, medical reports, laboratory data and search results in the patient database), but may also be applied in a different context. It is thus possible for example to retrieve additional anatomical information when a medical image is displayed. For example, where the patient themselves, or a medically untrained person, is to be notified of the content of an image, the method can also be applied to the effect that, in response to a corresponding activation signal, anatomical reference data will be retrieved in respect of the relevant image zone. For example, a brief description of the relevant organ may be inserted on the user interface (e.g. for the liver, the heart, the large intestine, etc.). Depending upon the field of application, a search will be conducted in different databases. In the latter case, for example, a publicly-accessible Internet database such as Wikipedia may be searched whereas, in a diagnostic context, searches will generally be executed in scientific and medical databases.

The embodiments of the method according to the invention described above may also be configured as a computer software product with a computer program, wherein the computer will proceed with the execution of the method according to embodiments of the invention, as described above, when the computer program concerned is run on a computer or a computer processor.

An alternative example embodiment also comprises a computer program with a computer program code for the execution of all the method steps in the method claimed or described above, when the computer program is run on the computer. To this end, the computer program may also be stored on a machine-readable storage medium.

An alternative example embodiment involves the provision of a storage medium, which is designed for the storage of the computer-implemented method described above, and can be read by a computer.

In the context of example embodiments of the invention, not all the method steps will necessarily be executed on one and the same computer entity, but may also be executed on different computer entities. The sequence of method steps may also be varied, where applicable.

It is also possible for individual elements of the method described above to be able to be executed in one commercial unit, while the remaining components are executed in a separate commercial unit, thereby constituting a distributed system as it were.

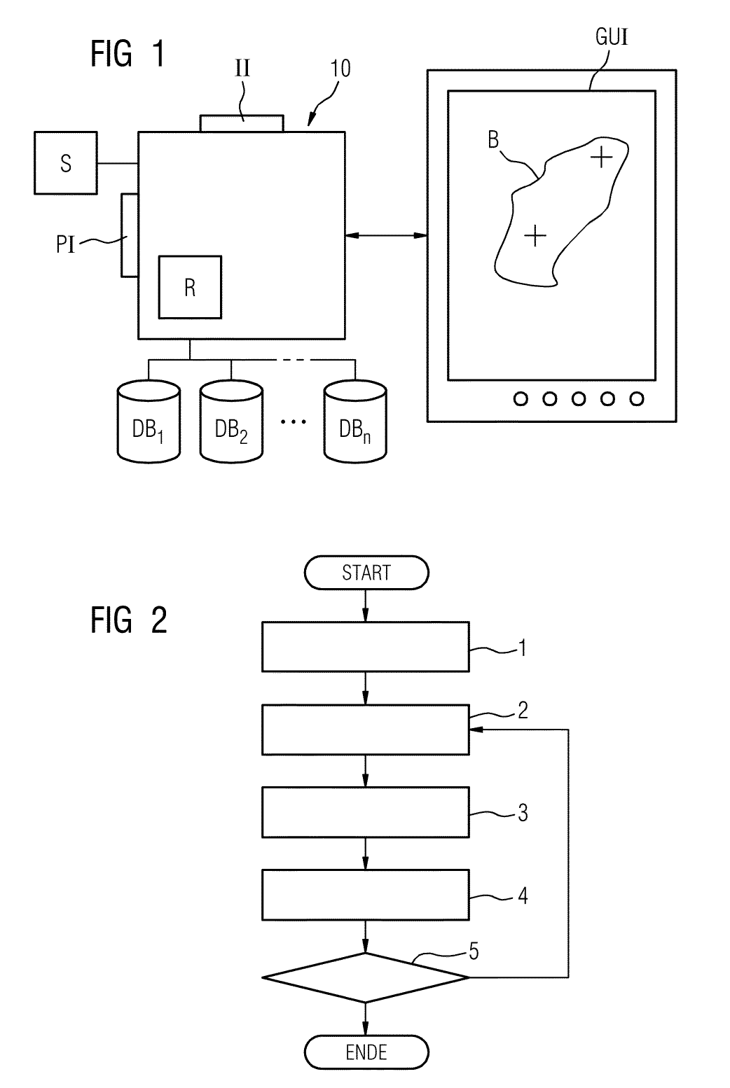

FIG. 1 shows a contextual overview of the application of a rendering device 10. The rendering device 10 is arranged for data exchange with a monitor or a user interface, specifically a graphical user interface GUI, which may be provided in various configurations. For example, the interface may be configured as the monitor of a computer system, or as a portable computer-based unit with a graphical user interface GUI such as e.g. an iPad, a smartphone, a laptop or similar. The function of the graphical user interface GUI is the representation of medical images B and, on the basis of the medical image entities represented, the retrieval of reference data R from networks and/or databases, which are then available for display on the graphical user interface GUI.

On the interface (hereinafter, the term “graphical user interface” is also abbreviated to “interface”), an image B comprising a number of partial images or a plurality of medically relevant images may be displayed, which are then used as the basis for a data search.

As shown in FIG. 1, the rendering device 10 comprises an input interface II, a parser interface PI and, via a network (e.g. the Internet), can access a minimum of one database DB. As an option, the rendering device 10 may also comprise a memory S for the storage of processed data. To this end, a database management function can be accessed for the configuring of the archiving time of stored data, by way of example. Naturally, connection to other databases (such as Wikipedia or PubMed, etc.) will also be possible. Databases will preferably be accessible via the Internet. In general, access and authentication measures will be applied for this purpose, in order to ensure reliable database access.

The input interface II is designed for the inputting of at least one image B, which will preferably be represented on the graphical user interface GUI, and for the acquisition and localization of an input signal on the said graphical user interface GUI.

The parser interface PI interacts with a parser P, which is designed for parsing an imported image B, in order to allow the generation of at least one identifier ID for the at least one relevant image B, and for the association of the identifier ID with the relevant image B.

The rendering device R is designed for the automatic generation of a search function for retrieval from a plurality of accessible databases DB using the specified identifier ID. The search function is preferably implemented in a retrieval unit RE, and permits the acquisition of reference data R. The respective results of database searches are combined in a single unit or processor, and consolidated into a single result. The object of the consolidation step is the combination of the reference data R identified in an overall result, which is then routed to the graphical user interface GUI. Additional control data is referred by the rendering device 10 to the GUI interface which, in addition to the reference data R, includes control information for the configuration of the position in which reference data are to be displayed on the monitor. To this end it will be possible, in a preliminary configuration phase, to select an insertion position at which the reference data R is to be displayed on the image. For example, a setting may be configured to the effect that reference data R will not cover the base image B or the relevant partial image B.

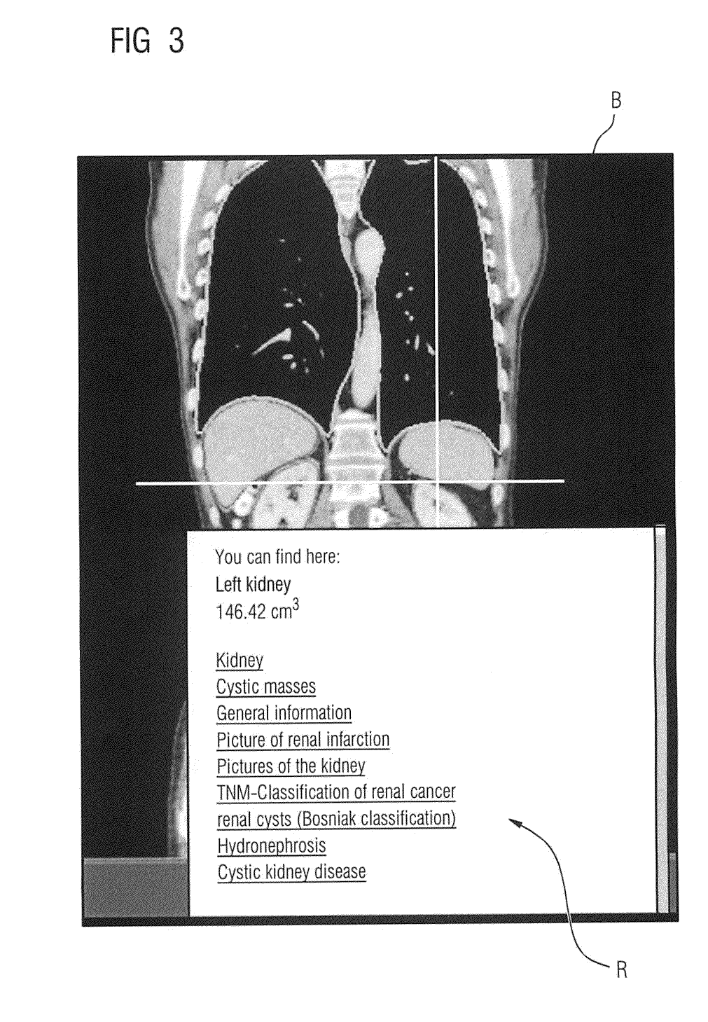

An example of a combined representation of this type is shown in FIG. 3. In this case, the graphical user interface GUI is to display a computed tomography image which shows an overhead view of the body of the patient, and which includes a representation of the kidneys. The cross-hair, which is represented schematically in FIG. 3, indicates that the user has marked the image zone of the left kidney on this imported image. Accordingly, the user wishes to obtain additional information on the left kidney. This additional information is delivered as reference data R by means of access to the various accessible databases, and is represented schematically in FIG. 3 by a window which incorporates hyperlinks (by way of example based upon a Bosniak classification for renal cysts). In this case, the reference data R includes a definition of the anatomical zone concerned (in this case: “left kidney”), together with an indication of size/volume (in this case: 146.42 cm³). The reference data R also includes selected hyperlinks, which are able to be activated, and can be clicked-on by the user to access additional representations. The reference data R is specifically tailored to the application concerned and, in this case, will only be relevant to the kidney area. In other words, this reference data will not be displayed if the user has clicked on the heart region.

In a further embodiment, it is possible to insert reference data R, not only in the form of hyperlinks, but also in the form of activated referrals for the display of the relevant data records (image data, text data, acoustic data or media data files, such as streaming videos) on the graphical user interface. It is also possible for a list of links to be displayed in the window.

In an example embodiment, additional information presented in the form of reference data R may be prioritized, in the interests of the adaptation thereof to the relevant application. If the user is e.g. a practitioner, it is not necessary for basic anatomical information to be shown in a prominent position (e.g. the primary position). This information (which will generally be familiar to a medically trained user) may be shown at a subordinate position in the list, whereas data from current medical studies will be assigned a higher priority, and will be shown at a higher position in the list.

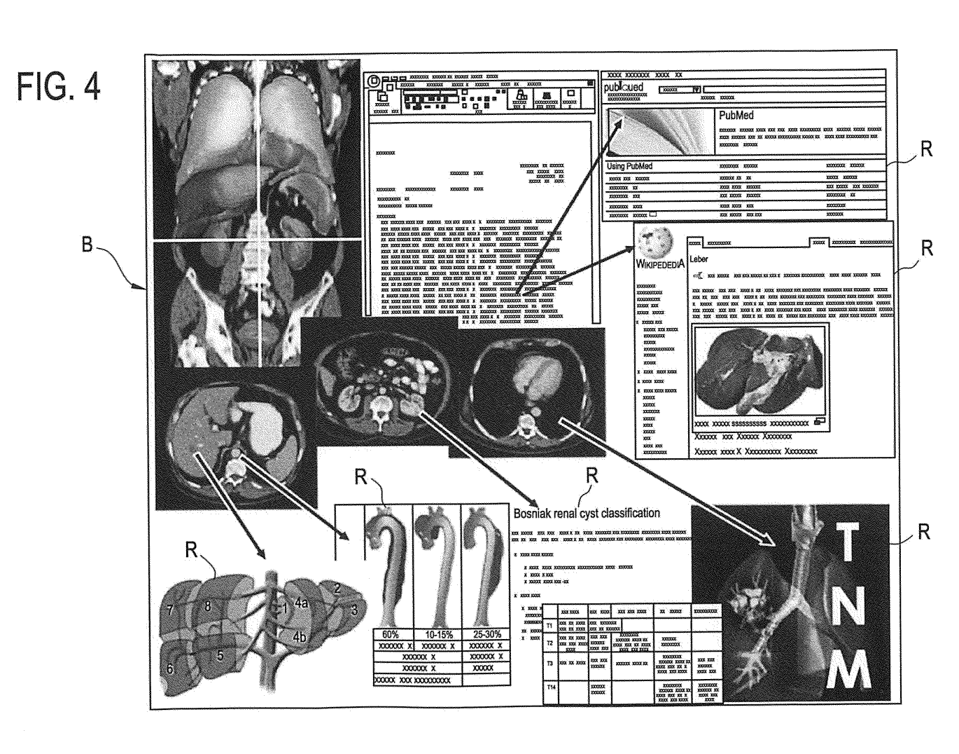

A further example of visual representation on the graphical user interface GUI is shown in FIG. 4. In this case, a word processing function (e.g. Word) is shown in a central position, which represents a diagnostic context. On the left-hand side, representations B of computed tomography images and body-section radiographic images of the patient to be diagnosed are shown. It is hereby specified that the images concerned are not necessarily computed tomography images, but may include a combination of different modalities, including a combination of MRT images, ultrasound images, PET images and CT images, for example, in which the user may activate specific image zones. On the basis of the image zones selected, further to the execution of the rendering process, additional information in the form of reference data R is inserted on the graphical user interface GUI. In FIG. 4, this is shown on the right-hand side and in the lower part of the GUI interface. In FIG. 4, reference data is also designated by the reference letter R. As is seen in FIG. 4, reference data may assume various data formats, and may be configured by way of example in the form of hyperlinks, inserted web pages, further graphical representations, text files, diagrams and/or in an acoustic format, etc.

On the images represented, the user will generally use a mouse click to activate one zone or a number of zones or partial images, which will form the basis for a reference data search. A search of databases will then be executed on the basis of the activated image zone. Alternatively, however, the search may be based upon a textual input, which is executed by way of example by the tagging of specific terms or concepts in the diagnosis. Accordingly, as soon as the user clicks on a specific term in the diagnostic report, or tags the said term, this term can be referred to the rendering unit 10, for the purposes of the automatic generation of a search function. Naturally, it is possible to tag a number of concepts, which are then applied for the execution of a search function by means of a mathematical combination function (AND operation). Alternatively, it is possible to execute a search function on the basis of a textual input and an image zone input. In this case, the search for reference data is conducted on the basis of the activated image zones, and on the basis of the activated (textual) concepts (for example in the diagnostic report).

Depending upon the site of interest and the context of application, it is possible to execute a preliminary configuration step in order to determine which reference data R is to be displayed at which location. By this configuration, for example, the representation of reference data may be restricted to image data. Alternatively, a setting may be entered whereby only referrals to specialized medical databases will be displayed. Further configuration parameters may be set in a pre-processing phase. For example, the user may define the position at which data is to be represented (insertion position), the duration of insertion of reference data R and/or the priority or form of representation to be applied (overlaid or transparent, as a link or by the direct insertion of text etc.).

A flow process for an example embodiment of the method is described below, with reference to FIG. 2. An object of an embodiment of the method is the control of the graphical user interface GUI for the purposes of the retrieval of medical reference data R from a plurality of accessible databases DB, which are accessible via the Internet.

An embodiment of the method is divided into two phases:
1.A pre-processing phase. In the pre-processing phase, configuration parameters may be defined, including by way of example the automatic definition of an insertion position, the duration of insertion, the selection of databases and further parameters for the configuration of the search function, for example the data format, etc.
2. The search phase. This phase involves the generation of the search query on the basis of image zone data or specialized medical terms, access to the relevant databases and the consolidation of the search result. The search result is then represented by the insertion of the reference data R on the GUI interface.

If an image zone-based search is to be conducted at all, it is assumed, for the purposes of the present application, that the images B represented have already been analyzed (or pre-processed). To this end, they are generally stored in an image archive, and are processed using an image parser P. The parser P undertakes the segmentation of image zones which represent various anatomical regions or organs, vessels, anatomical blood vessel ramifications, lymph node zones, etc. The segmented zones are saved in an annotation database. A specific significance is preferably allotted to each segmented zone, which is represented by a semantic identifier ID. The identifier ID is based upon an ontology, which is saved in a knowledge database. An example of semantic annotations of this type may be found in Seifert, S.; Kelm, M; Moeller, M; Mukherjee, S; Cavallaro, A; Huber, M. and Comaniciu, D., “Semantic Annotation of Medical Images in “SPIE 2010 Medical Imaging”, the entire contents of which are hereby incorporated herein by reference.

In other words, images depicted on the GUI have already undergone pre-processing, in that they have already been routed to a parser P, for the purposes of the semantic identification of the various image zones.

Once the inputting of a segmented and parsed image via the input interface II is complete, the process proper can begin. In other words, the analysis—or pre-processing phase —is not complete until the full image content B has been routed to the parser P, in order to permit the identification of all the relevant partial images or images by means of identifiers ID.

An initial step involves the acquisition of an activation signal on the graphical user interface GUI. The object of the activation signal is the modification of the customary or standardized display of medical images, such that the search function for reference data according to the invention will be activated. The activation signal may take the form of a mouse click on the user interface, by way of example, or the entry of a specific key combination on the keypad. Immediately the activation signal has been acquired in step 1, the position of an input signal on the graphical user interface GUI, in relation to the image B represented thereupon, will be acquired in step 2. As soon as the user has identified a specific image zone, or a number of partial images on the image B (for example by clicking on a mouse button), these signals will be classified as input signals, and will be recorded by the system accordingly. Coordinates or positional values in relation to the image represented will be recorded for each input signal, and routed to the rendering unit 10 for further processing.

Pre-processing allows the relevant identifiers ID to be associated with the localized input signals. This is completed in step 3.

In step 4, at least one search function can then be generated for retrieval from the databases DB. Preferably, this will proceed on a fully-automatic basis, without any kind of user interaction. The search function is based upon the identifiers specified for the retrieval of reference data.

Once access to the accessible databases DB has been achieved, the result of the inquiry is consolidated for the subsequent delivery of a search result in step 5. To this end, the graphical user interface GUI is controlled in order to effect the insertion of the consolidated search result in the form of processed reference data R at the predetermined insertion position on the image B, preferably in a combined representation with the said image B. The control function for the graphical user interface GUI is represented in FIG. 2 by the reference FIG. 5. The method may then be terminated, or may be resumed e.g. from step 2 for the positional identification of input signals. Depending upon the configuration, it is possible for the activation phase to be prolonged until such time as a deactivation signal is acquired for the termination of the search function. Alternatively, a setting may be entered such that the activation signal will only be valid for a single pass. Accordingly, following the acquisition of an activation signal, and immediately the specific input signals have been acquired on the graphical user interface GUI and referred to the rendering device 10, the said rendering device 10 will switch back from search mode to the normal display mode. Only in search mode can image zones be identified by the entry of an input signal, which will then be used as a basis for the search for reference data R.

As already indicated above, the preferred format for the input signal is based upon a mouse click or a cursor movement, with a subsequent keypad operation. Naturally, in other embodiments, speech commands may be applied, either alternatively or cumulatively. As soon as the input signals have been acquired, these signals are routed to the rendering device 10, in order to “feed” a region-based query engine with input data. Calculated 3D positional coordinates (two-dimensional positional coordinates are mapped on 3D image files in this case; this is achieved using standardized medical visualization software), which have been entered by the user as an input signal, will also be delivered. By accessing the parser P, these coordinate values can be mapped as concept labels or identifiers ID, in order to permit the semantic identification of the image zone concerned (e.g. right heart valve, left kidney, etc.). A locator is accessed for this purpose.

The semantic identifiers ID for the selected image zones provided by the parser P may be extended by way of an expansion function. Using this function, for example, the user may define additional identifiers which are to be used as a basis for the execution of the search. As an alternative to the targeted definition of identifiers, further concepts or concept labels may be defined. The concept labels may be delivered by a “knowledge inference unit”, in order to allow the inclusion of adjoining regions, overlapping or surrounding anatomical regions in the search. Accordingly, for example, a liver-based search may be extended to include the abdomen, as a tissue which surrounds and encloses the liver. The search will cover a larger area accordingly.

According to an example development of the invention, the list of identifiers may be restricted by way of example on the basis of the selection by the user of specific semantic identifiers only. For example, the medical workflow (for example the diagnosis completed) may be applied as the basis for this restriction. If the practitioner wishes to consider a previously diagnosed carcinoma as the basis for further searches for reference data R, there are no rational grounds for the delivery of basic anatomical information as reference data. This may be achieved by the execution of the selection function.

Once the list of identifiers—in its expanded or selected form, where applicable —has been established, the region—based query engine can deliver a search query generated to the reference databases DB, in order to allow the retrieval of the stored reference data R, e.g. in the form of hyperlinks and/or bookmarks. The resulting reference data R will correspond to the concepts which have been entered by means of the semantic identifiers. The hyperlinks are then routed back to the graphical user interface GUI, where they are displayed, together with a pop-up dialogue box, where applicable.

For the purposes of monitoring and maintenance, the system may also comprise a maintenance unit for the configuration of search results or links delivered. To this end, the user (generally also in the pre-processing phase, which precedes the execution phase of the search proper) enters specific configuration parameters, in order to generate the indication of preferred hyperlinks for a given type of region (for example an organ). Moreover, a service may be delivered whereby a list of pre-set hyperlinks is proposed to the user, from which the user then makes a selection.

Essentially, this service will include e.g. available websites, which may provide current scientific information on tumour growth, by way of example.

The solution according to an example embodiment of the invention will contribute advantageously to the acceleration and the qualitative enhancement of the diagnostic process by the automatic representation of appropriate reference information R, without the necessity for the user to repeat the manual activation of a separate search in different databases. By automatic reference to the selected image zones, queries are addressed to different databases, thereby permitting the representation of reference data R in the form of an overall search result on the graphical user interface GUI. To this end, reference data R is selected on the basis of the current context, specifically in respect of anatomy, pathology, workflow and/or the region of interest. Personal stipulations defined by the user may also be taken into consideration. Advantageously, search configuration parameters may be amended by the user at any time. This is even possible once the process has already been executed. The automatic search for reference data R includes an intelligent search, in order to permit the delivery of pre-filtered information which is relevant to the application concerned. For example, if the user has clicked on one of the two kidneys, it will automatically be ensured that no reference data R in respect of the heart, or in respect of any other medically unrelated regions, will be retrieved. The quantity of reference data may be advantageously reduced accordingly, thereby ensuring that the user will not be overwhelmed by a surplus of unnecessary information.

Finally, it is hereby specified that, in principle, the description of the invention and the example embodiments are not to be considered by way of limitation to a specific physical embodiment of the invention. Specifically, it will be evident to a person skilled in the art that the invention, whether in whole or in part, may be distributed between software and/or hardware and/or between a number of physical products —specifically including computer software products.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims.

Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

### LIST OF REFERENCES

GUI graphical user interface
B image or partial image
10 rendering device
II input interface
S memory
PI parser interface
R retrieval unit
DB database
1 acquisition of an activation signal
2 localization of input signals
3 definition of the identifiers associated with input signals
4 automatic generation of a search function
5 control of the graphical user interface GUI with reference data R and control data

What is claimed is:

1. A rendering device for the control of a graphical user interface for the representation of medical reference data in respect of at least one image, comprising:
an input interface configured to input at least one image, and configured to acquire and localize an input signal on the graphical user interface;
a parser interface to an image parser, configured to parse an imported image, in order to allow the generation and classification of at least one identifier for the at least one image; and
a retrieval unit, configured to automatically generate a search function for retrieval data from a variety of accessible databases with reference to the identifier specified, in order to acquire reference data, wherein the rendering device is designed for the control of the graphical user interface, such that the processed reference data is insertable into the image at an insertion position, and is displayable together with the image.

2. The rendering device of claim 1, further comprising or being configured for the exchange of data with:
a memory, including a classification function for the association of at least one of the processed reference data, the insertion position and the relevant image with its respective identifier.

3. The rendering device of claim 2, wherein the image comprises partial images, wherein each of the partial images is separately identified and separately associated with different identifiers, and wherein the rendering device is controlled by reference to said partial images.

4. A diagnostic image system for medical image data, using the rendering device of claim 1.

5. A method for the control of a graphical user interface for the retrieval of medical reference data from a plurality of accessible databases, accessible via the Internet, on the basis of a minimum of one image represented on the graphical user interface, wherein the at least one image is imported and parsed, in order to permit the generation and allocation of an identifier for the relevant image, the method comprising:
following the acquisition of an activation signal, localizing input signals on the graphical user interface in relation to the image represented Definition of the identifiers associated with the image;
automatically generating at least one search function for the retrieval of information from the databases using the specified identifiers, in order to permit the acquisition of reference data; and
controlling the graphical user interface, in order to effect the insertion of the processed reference data at an insertion position on the image, in a combined representation with the image.

6. The method of claim 5, wherein the identifier comprises a number of segments, each of the segments relating to different sections of the image or to different images, such that the search function may be generated on the basis of the totality of images sections or a selection thereof.

7. The method of claim 5, wherein an expansion function is applied, whereby the at least one specified identifier is expanded by reference to a recorded medical workflow, thereby permitting the execution of the search function on the basis of the at least one specified and expanded at least one identifier.

8. The method of claim 5, wherein a selection function is applied, whereby the at least one specified identifier is restricted by reference to a recorded medical workflow, thereby permitting the execution of the search function on the basis of specified and restricted identifiers.

9. The method of claim 5, wherein a training function is applied for at least one of the control of a selection of reference data on the basis of recorded referrals to previous applications of the process and the generation of default reference data.

10. The method of claim 5, wherein supplementary to or in combination with the reference data inserted in the image, a pop-up dialogue box is displayed on the graphical user interface.

11. A computer software product, loadable or pre-loaded in a memory of a computer, including computer-readable commands for the execution of the method of claim 5 when the commands are executed on the computer.

12. The diagnostic image system of claim 4, wherein the diagnostic image system is for X-ray-based image data.

13. The rendering device of claim 1, wherein the image comprises partial images, wherein each of the partial images is separately identified and separately associated with different identifiers, and wherein the rendering device is controlled by reference to said partial images.

14. A diagnostic image system for medical image data, using the rendering device of claim 13.

15. The method of claim 6, wherein an expansion function is applied, whereby the at least one specified identifier is expanded by reference to a recorded medical workflow, thereby permitting the execution of the search function on the basis of the at least one specified and expanded at least one identifier.

16. The method of claim 6, wherein a selection function is applied, whereby the at least one specified identifier is restricted by reference to a recorded medical workflow, thereby permitting the execution of the search function on the basis of specified and restricted identifiers.
